(19) United States
(12) Patent Application Publication
(10) Pub. No.: US 2014/0205750 A1
(43) Pub. Date: Jul. 24, 2014

(54) CATHODE ACTIVE MATERIAL COATING

(71) Applicant: Applied Materials, Inc., Santa Clara, CA (US)

(72) Inventors: Lu YANG, Fremont, CA (US); Miaojun WANG, San Jose, CA (US); Dongli ZENG, Sunnyvale, CA (US); Robert Z. BACHRACH, Burlingame, CA (US)

(21) Appl. No.: 14/153,447

(22) Filed: Jan. 13, 2014

Related U.S. Application Data
(60) Provisional application No. 61/756,153, filed on Jan. 24, 2013.

(51) Int. Cl. H01M 4/1391; H01M 4/04

(52) U.S. Cl. CPC H01M 4/1391; H01M 4/0402; H01M 4/0471
USPC 427/126.4; 118/69; 118/716; 427/58; 427/126.1; 427/126.3

(57) ABSTRACT

Embodiments of the present disclosure relate to apparatus and methods for forming particles of cathode active materials with a thin protective coating layer. The thin protective coating layer improves cycle and safety performance of the cathode active material. A coating precursor may be added at various stages during formation of the particles of cathode active materials. The thin layer of chemical may be a complete coating or a partial coating. The coating may include a thin layer of chemicals, such as an oxide, to improve cycle performance and safety performance of the cathode active material.

### CROSS-REFERENCE TO RELATED APPLICATIONS

This application claims benefit of U.S. Provisional Application Ser. No. 61/756,153 (Attorney Docket No. 017365L), filed Jan. 24, 2013, which is incorporated herein by reference.

### FIELD

Embodiments of the present disclosure relate generally to high energy batteries. More specifically, methods and apparatus for forming cathode active materials for high energy lithium batteries are disclosed.

### BACKGROUND

Fast-charging, high-capacity energy storage devices, such as super-capacitors and lithium (Li) ion batteries, are used in a growing number of applications, including portable electronics, medical devices, transportation, grid-connected large energy storage, renewable energy storage, and uninterruptible power supplies (UPS).

Modern rechargeable energy storage device generally includes a cathode, an anode, electrolyte disposed between the cathode and the anode, and a separator separating the cathode and the anode. In most commercial lithium-ion batteries, cathode is the source of lithium metal ions, typically lithium transition metal oxides, such as LiMn₂O₄, LiCoO₂, LiNiO₂, or combinations of Ni, Li, Mn, and Co oxides. The anode is a sink of the metal ions, for example graphite or silicon. Both cathode and anode also includes non-active materials such as conductive carbon and polymer binders to ensure good electronic and mechanical properties of the electrodes. The separator provides for the separation of electronic transport between cathode and anode. Among all the components, cathode active material affects various parameters of rechargeable energy storage devices, such as charge/discharge capacity, rate performance, cycle performance, and safety.

Accordingly, there is a need for apparatus and methods for forming cathode active material with improved performance.

### SUMMARY

Apparatus and methods for forming coated cathode active materials are described.

One embodiment of the present disclosure provides an apparatus for forming cathode active material by continuous flow. The apparatus includes a mixing unit that generates a mixture or a solution of precursors, a synthesizing unit coupled to the mixing unit to synthesize particles of cathode active material from the mixture or solution of precursors, a cooling unit coupled to an outlet of the synthesizing unit, a transferring channel coupled downstream to the cooling unit, a collecting unit connected to the transferring channel for collecting the particles of cathode active material, and an annealing unit downstream to the collecting unit to anneal the particles of cathode active material. The apparatus further includes a coating source unit that provides a coating precursor to the apparatus for forming a coating on the particles of cathode active material. The coating source unit is disposed at the mixing unit, the synthesizing unit, the transferring channel, the collecting unit, or the annealing unit. Alternatively, an independent coating unit is coupled between the collecting unit and the annealing unit, or a standalone unit.

Another embodiment of the present disclosure provides a method for forming cathode active material. The method includes forming a mixture or solution of precursors comprising metal ions, synthesizing the mixture or solution of precursors to form particles of cathode active material, cooling and transferring the particles of cathode active material to a collecting unit, collecting the particles of cathode active material in the collecting unit and annealing the collected particles of cathode active material. The method further includes adding a coating precursor to form a coating over the particles of cathode active material. Adding the coating precursor is performed during one of the following times: forming the mixture or solution of precursors, cooling and transferring the particles of cathode active material, collecting the particles of cathode active material, after collecting and before annealing the particles of cathode active material, annealing the particles of cathode active material, and after annealing the particles of cathode active material.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic view of a system for forming cathode active materials according to one embodiment of the present disclosure.

FIG. 2A is a flow chart of a method for forming cathode active materials with coating according to one embodiment of the present disclosure.

FIG. 2B is a flow chart of a method for forming cathode active materials with coating according to one embodiment of the present disclosure.

FIG. 2C is a flow chart of a method for forming cathode active materials with coating according to one embodiment of the present disclosure.

FIG. 2D is a flow chart of a method for forming cathode active materials with coating according to one embodiment of the present disclosure.

FIG. 2E is a flow chart of a method for forming cathode active materials with coating according to one embodiment of the present disclosure.

FIG. 2F is a flow chart of a method for forming cathode active materials with coating according to one embodiment of the present disclosure.

FIG. 3 schematically illustrates a reaction for coating cathode active material according to the method showing in FIG. 2B.

FIG. 4A is a graph showing first cycle charge/discharge curves of batteries with various cathode active materials.

FIG. 4B is a graph showing second cycle charge/discharge curves of batteries with various cathode active materials.

FIG. 4C is a graph showing cycle performance of batteries with various cathode active materials.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the present disclosure relate to apparatus and methods for forming cathode active materials for fast charging high capacity energy storage devices. More particularly, embodiments of the present disclosure relate to apparatus and methods for forming particles of cathode active materials with a thin protective coating layer. The thin protective coating layer improves cycle and safety performance of the cathode active material. A coating precursor may be added at various stages during formation of the particles of cathode active materials. The thin layer of chemical may be a complete coating or a partial coating. The coating may include a thin layer of chemicals, such as an oxide, to improve cycle performance and safety performance of the cathode active material.

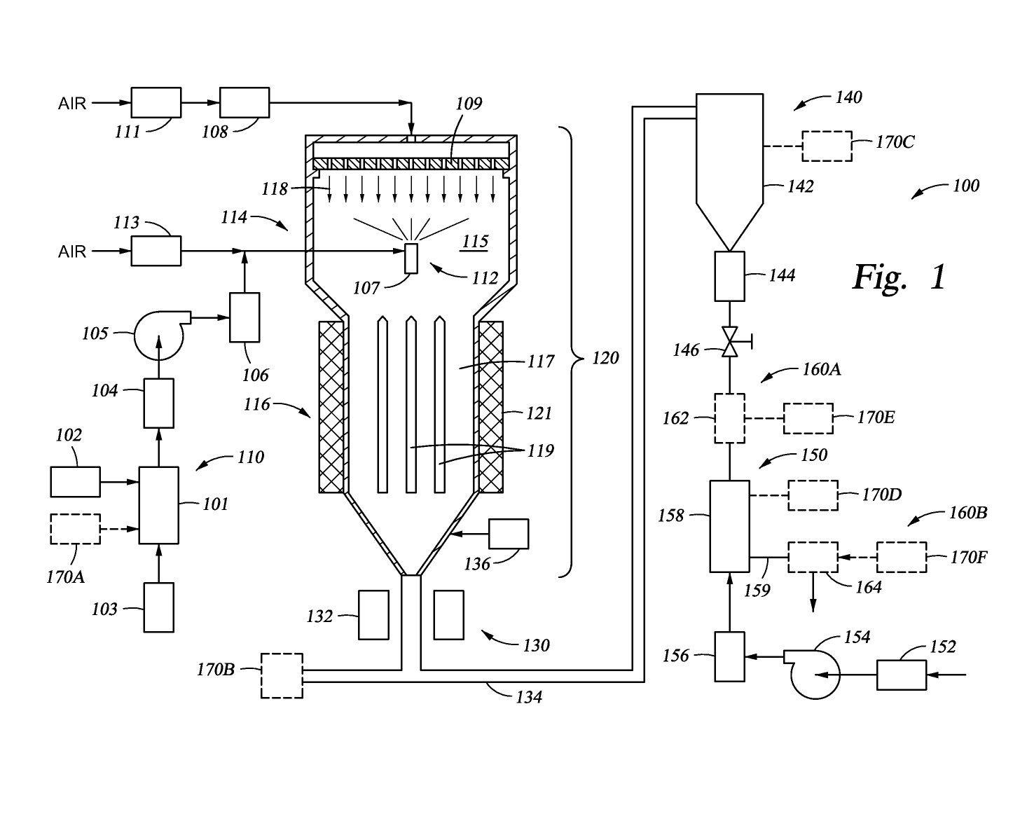

FIG. 1 is a schematic view of a system 100 for forming cathode active materials according to one embodiment of the present disclosure. The system 100 is configured to synthesize particles of cathode active material or other solid materials using a controlled continuous flow approach according to embodiment of the present disclosure.

The system 100 may include a mixing unit 110 configured to generate a solution or a mixture of precursors for the solid materials to be produced. The system 100 may also include a synthesizing unit 120 coupled downstream to the mixing unit 110. The synthesizing unit 120 is configured to synthesize the solution or mixture of precursors to form particles of solid materials, such as particles of cathode active material. The synthesizing unit 120 may include a droplet generator 112, a dryer 114, and a reactor 116. The droplet generator 112 for generating droplets for producing materials in powder form is connected downstream to the mixing unit 110. The dryer 114 and the reactor 116 are connected downstream to the droplet generator 112. The dryer 114 and the reactor 116 provide a multiple stage high temperature reactor for converting droplets to solid particles. A cooling unit 130 and a transferring channel 134 connect the dryer 114 and reactor 116 to a collecting unit 140 for collecting the synthesized particles. The system 100 may also include an annealing unit 150 for a heat treatment prior to packaging. The annealing unit 150 may be connected to the collecting unit 140.

During operation, the flow of precursors starts from the mixing unit 110 towards the droplet generator 112. The droplet generator 112 may be disposed in or coupled to the dryer 114. The precursors are dispersed from the droplet generator 112 into the dryer 114 and flow through the dryer 114 into the reactor 116 connected downstream to the dryer 114. The flow exits the reactor 116 to the cooling unit 130, then through a transferring channel 134 to the collecting unit 140, and then to the annealing unit 150 selectively coupled to the collecting unit 140, where final product of the solid material is formed.

Embodiments of the present disclosure also include a coating source unit for introducing a coating material to the solid material, such as cathode active material, during the fabrication process. As shown in FIG. 1, the coating source unit may be located in various stages of the continuous flow process. For example, a coating source unit 170A may be coupled to the mixing unit 110 to form a precursor mixture comprising a coating precursor so that particles with coating materials are synthesized in the dryer 114 and the reactor 116. Alternatively, a coating source unit 170B may be coupled downstream to the cooling unit 130 to introduce a coating liquid or gas to the cooled and synthesized solid material. Alternatively, a coating source unit 170C may be coupled to the collecting unit 140 to add a coating material to the synthesized solid material during the collecting process. Alternatively, a coating source unit 170D may be coupled to the annealing unit 150 to introduce the coating material during annealing. Alternatively, the system 100 may include an independent coating station 160A disposed between the collecting unit 140 and annealing unit 150 to perform the coating function alone. The independent coating station 160A may include a coating source unit 170E to introduce a coating solution to the synthesized and collected solid material. Alternatively, the system 100 may include a standalone coating station 160B after the annealing process. The standalone coating station 160B may include a coating source unit 170E to introduce a coating solution to the annealed solid material.

The mixing unit 110 is configured to generate a solution or a slurry including precursors for the solid materials to be produced. The mixing unit 110 may include a mixer 101, a precursor source 102 for supplying one or more solid precursors to the mixer 101, and a solvent/liquid base source 103 for supplying a solvent or a liquid base to the mixer 101. A container 104 may be connected to the mixer 101 to store the prepared solution or slurry. In one embodiment, the coating source unit 170A is coupled to the mixer 101 to supply a coating material to the mixer 101.

For manufacturing cathode active material, the precursor source 102 may include precursors comprising metal ions, such as ions of lithium, nickel, cobalt, iron, manganese, vanadium, and magnesium. In one exemplary embodiment, lithium, nickel, manganese, cobalt, and iron are used. The metal ions may be in the form of salts, with anions that may decompose under appropriate conditions to yield reactive species. Such anions include inorganic anions such as nitrate, nitrite, phosphate, phosphite, phosphonate, sulfate, sulfite, sulfonate, carbonate, bicarbonate, borate, and mixtures or combinations thereof. Organic ions, such as acetate, oxalate, citrate, tartrate, maleate, ethanoate, butanoate, acrylate, benzoate, and other similar anions, or mixtures or combinations thereof, may also be used instead of, or in combination with, inorganic anions.

The precursor source 102 may also include carbon containing components, such as precursors for forming amorphous carbon particles. The amorphous carbon particles may agglomerate around particles of cathode active material and ultimately deposit with the battery-active particles, providing improved conductivity of the deposited medium, along with density and porosity advantages in some cases.

The precursor source 102 may also include nitrogen containing compounds to facilitate forming uniform nuclei from the droplets, so that solid spherical particles of cathode active material are obtained. Such compounds may include urea, ammonium nitrate, glycine and ammonia.

The solvent/liquid base source 103 may include water, alcohols, ketones, aldehydes, carboxylic acids, amines, methanol, ethanol, isopropanol, ethylene glycol, propylene glycol, acetone, methyl ethyl ketone, formaldehyde, acetaldehyde, acetic acid, maleic acid, maleic anhydride, benzoic acid, ethyl acetate, vinyl acetate, dimethylformamide, dimethylsulfoxide, benzene, toluene, and light paraffins, or mixtures thereof.

The coating material supplied from the coating source unit 170A may include precursors for forming a thin layer of chemical coating, such as Al₂O₃, AIF₃, LiAlO₂, AIPO₄, ZrO₂, ZrF₄, SiO₂, SnO₂, MgO, on surfaces of the cathode active material. A suitable amount of coating precursor may be introduced such that the cathode active material produced by the system 100 includes less than 3% in weight of the coating material. In one embodiment, the coating source unit 170A may include a precursor comprising Al(NO₃)₃ or aluminum alkyl for forming a coating material comprising Al₂O₃ on the cathode active material.

The droplet generator 112 is configured to generate droplets for producing materials in powder form. The droplet generator 112 may include a dispersion member 107. The dispersion member 107 may be an atomizer, a nebulizer, or a monodispersion or semi-monodispersion droplet generator operable to produce small droplets having uniform size. As shown in FIG. 1, the dispersion member 107 may be disposed within the dryer 114 to disperse droplets in the dryer 114. The droplet generator 112 may also include a pump 105 configured to produce a pressured flow from the container 104 to the dispersion member 107. Optionally, a filter 106 may be coupled between the pump 105 and the dispersion member 107. In one embodiment, a flow of filtered air may be provided to the dispersion member 107 through a filter 113 to provide some separation of the droplets emerging from the dispersion member 107.

The dryer 114 and the reactor 116 form a tower with the dryer 114 above the reactor 116. The dryer 114 may define an inner volume 115. The dispersion member 107 may be disposed to disperse droplets generated from the solution/slurry to the inner volume 115. Flow of heated air 118 may be delivered to the inner volume 115 to heat the droplets and evaporate some or all of the liquid from the droplets. In one embodiment, the flow of heated air 118 may be supplied to a heater 108 from a filter 111 then through a showerhead 109 to the inner volume 115.

The flow of heated air 118 in the dryer 114 that evaporates some or all of the liquid from the droplets, increasing the temperature of the droplets and resulting particles that emerge, from near ambient temperature at the inlet of the reactor 116 to near a reaction temperature of 500° C. or less at the exit of the reactor 116. The intermediate material that exits the dryer 114 may be a dry powder of particles entrained in a gas stream, a moist powder of particles entrained in a gas stream, a collection of liquid droplets and particles entrained in a gas stream, or a collection of liquid droplets entrained in a gas stream, depending on the degree of drying performed in the dryer 114. The particles may be nano-sized particles or micro-sized particles, or a mixture thereof. The particles may be particles of metal salt precipitated from the liquid precursor material, particles of mixed metal salt and oxygen, representing partial conversion of metal ions to cathode active material, and particles fully converted to cathode active material comprising mainly metal ions and oxygen.

The reactor 116 is configured to convert metal ions into cathode active materials. The reactor 116 includes an inner volume 117 for the intermediate material from the dryer 114 to react and be synthesized into desired solid material. Depending on the composition of the intermediate material, the reaction temperature in the reactor 116 may vary. In one embodiment, the reaction temperature may be about 1000° C. In another embodiment, the reaction temperature may be less than about 500° C., for example less than about 400° C. The reactor 116 may include temperature control means, such as heaters and/or cooling ducts to conduct the reaction at desired temperatures. In one embodiment, the reactor 116 may be positioned vertically below the dryer 114 so that the inner volume 117 of the reactor 116 connects with the inner volume 115 of the dryer 114. In one embodiment, the reactor 116 may be a furnace having a thermally insulating wall 121 and a plurality of heating element 119 disposed in an inner volume 117.

The cooling unit 130 may be positioned below the inner volume 117 of the reactor 116. During operation, the flow of mixture exits the inner volume 117 of the reactor and enters the cooling unit 130. The flow mixture may comprise mainly particles of cathode active materials, exhaust gases, and inert gases. The reaction in the reactor 116 may occur at high temperature and the flow of mixture exiting the inner volume 117.

The cooling unit 130 may include a cooling means 132 applied to an outer wall of the transferring channel 134 to remove heat conducted by the outer wall. The cooling means 132 may be a gas flowed across the outer surface, or a cooling jacket may be applied with a cooling fluid. A source of dry gas 136 may be fluidly coupled into the cooling unit 130 to control humidity of the mixture as it cools.

In one embodiment, the coating source unit 170B may be coupled to the transferring channel 134 downstream to the cooling unit 130. The coating source unit 1708 may deliver a coating liquid or a coating gas to the cooled powder of solid material in the transferring channel 134 to form a thin coating on the particles of the powder. The coating liquid or coating gas supplied from the coating source unit 170B may include liquid or gas form of material for forming a thin layer of chemical coating, such as Al₂O₃, AIF₃, LiAlO₂, AIPO₄, ZrO₂, ZrF₄, SiO₂, SnO₂, MgO, on surfaces of the cathode active material. In one embodiment, the coating source unit 170B may include Al(NO₃)₃ or aluminum alkyl in liquid/gas phase for forming a coating material comprising Al₂O₃ on the cathode active material.

The collecting unit 140 is coupled to the transferring channel 134 to collect cooled powder of solid material, such as cooled powder of active cathode material. The collecting unit 140 may include a particle collector 142 and a particle container 144. The particle collector 142 may be any suitable particle collector, such as a cyclone or other centrifugal collector, an electrostatic collector, or a filter-type collector. The collecting unit 140 removes gas bubbles from the powder and generates solid material of uniform texture.

In one embodiment, the coating source unit 170C may be coupled to the particle collector 142. The coating source unit 170C may deliver a coating material to the particle collector 142 to form a thin coating on the particles of the powder during a particle collecting process. For example, the coating source unit 170C may form a film of coating material on an inner surface of the particle collector 142, so that a coating formed on the particles when the particles physically contact and scratch the inner walls of the particle collector 142 during collecting process. The coating material supplied the coating source unit 170C may include material for forming a thin layer of chemical coating, such as Al₂O₃, AIF₃, LiAlO₂, AIPO₄, ZrO₂, ZrF₄, SiO₂, SnO₂, MgO, on surfaces of the cathode active material.

The annealing unit 150 may be coupled to the particle container 144 to receive the collective particles of solid material for an annealing process. The annealing process transforms the collected solid material to desired crystal structure and improve its electrochemical properties. The annealing unit 150 may include an air filter 152, a pump 154, a heater 156, and an annealing container 158. The annealing container 158 is coupled to the particle container 144 in the collecting unit 140 to receive collected solid material. In one embodiment, a valve 146 may be disposed between the particle container 144 and the annealing unit 150 to selectively flow the collected particles from the particle container 144 to the annealing container 158. The air filter 152, the pump 154 and the heater 156 are linearly aligned to provide a flow of filtered heated air to the annealing container 158 for annealing. The annealing container 158 further includes an outlet to dispense annealed solid material for further process or packaging.

In one embodiment, the coating source unit 170D may be coupled to the annealing container 158. The coating source unit 170D may deliver a coating liquid or a coating gas to the annealing container 158 to form a thin coating on the particles of the powder during the annealing process. The coating liquid or coating gas supplied from the coating source unit 170D may include liquid or gas form of material for forming a thin layer of chemical coating, such as Al₂O₃, AIF₃, LiAlO₂, AIPO₄, ZrO₂, ZrF₄, SiO₂, SnO₂, MgO, on surfaces of the cathode active material.

As discussed above, a coating may be added to the solid material produced by the system 100 by one coating source unit 170A, 170B, 170C, or 170D integrated to one stage of the continuous flow. These embodiments are suitable to retrofit existing solid material production systems or arrangement. Alternatively, coating may be formed in an independent unit. The independent unit may be a coating station coupled upstream to the annealing unit 150, such as the coating station 160A. The independent unit may be a standalone station that is configured to perform coating downstream to the annealing unit 150, such as the coating station 160B.

The independent coating station 160A may include a coating container 162 for performing the coating process and a coating source unit 170E connected to the coating container 162. The coating station 160A may carry out precipitation reactions in the coating container 162 to form a coating. For example, particles of the solid material to be coated may be suspended in a solution of coating material to carry out reactions for coating. The coating source unit 170E may deliver solutions of chemicals for forming a coating, such as Al₂O₃, AIF₃, LiAlO₂, AIPO₄, ZrO₂, ZrF₄, SiO₂, SnO₂, MgO, on surfaces of the cathode active material. In one embodiment, the coating source unit 170E may deliver a solution of Al(NO₃)₃ or aluminum alkyl to the coating container 162 for forming a coating material comprising Al₂O₃ on the cathode active material.

The standalone coating station 160B is similar to the independent coating station 160A except the standalone coating station 160B is not directly connected to the system 100. The standalone coating station may include a coating container 164 for performing the coating process and a coating source unit 170F connected to the coating container 164. Solid material may be coated in the standalone coating station 1608 after the synthesizing is complete. For example, the solid material from the outlet 159 of the annealing unit 150 may be transferred to the coating container 164 for coating. The coating source unit 170F may deliver solutions of chemicals for forming a coating, such as Al₂O₃, AIF₃, LiAlO₂, AIPO₄, ZrO₂, ZrF₄, SiO₂, SnO₂, MgO, on surfaces of the cathode active material. In one embodiment, the coating source unit 170F may deliver a solution of Al(NO₃)₃ or aluminum alkyl to the coating container 164 for forming a coating material comprising Al₂O₃ on the cathode active material.

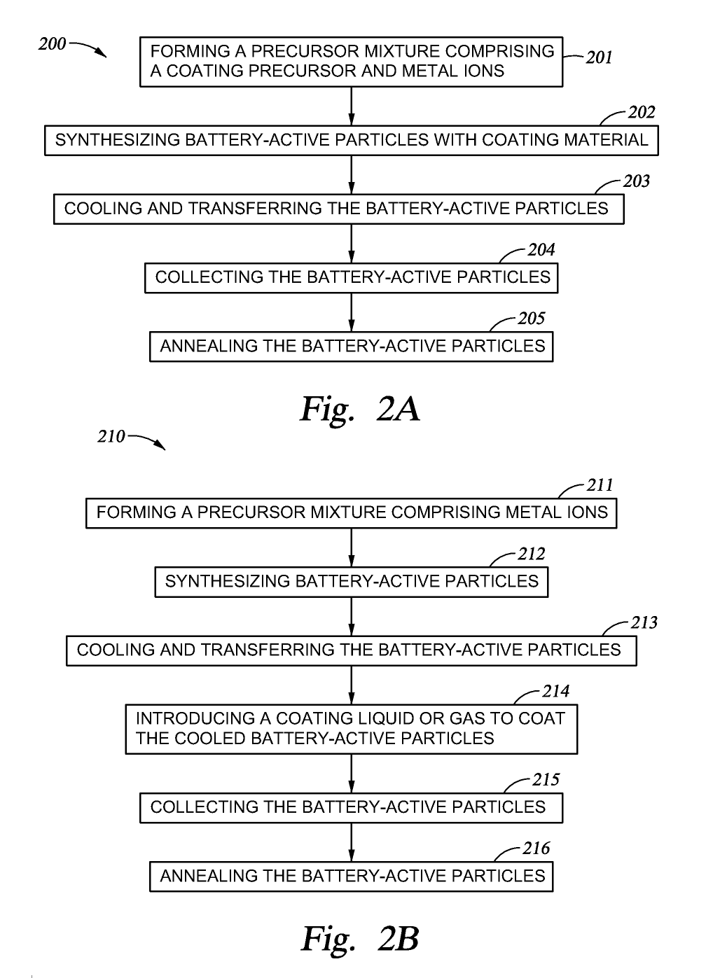

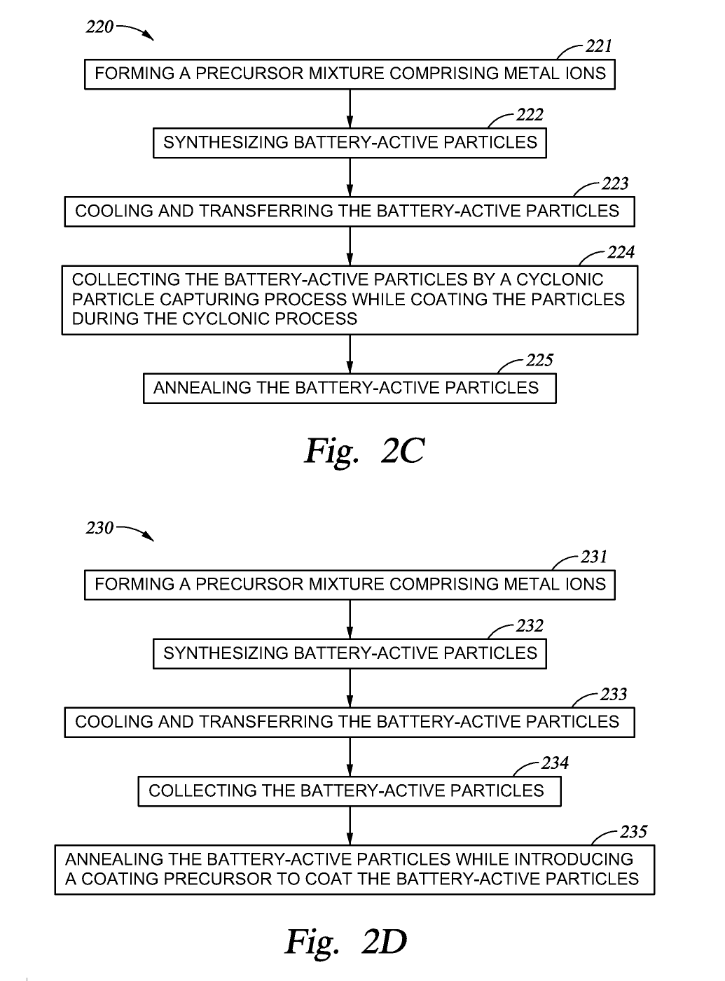

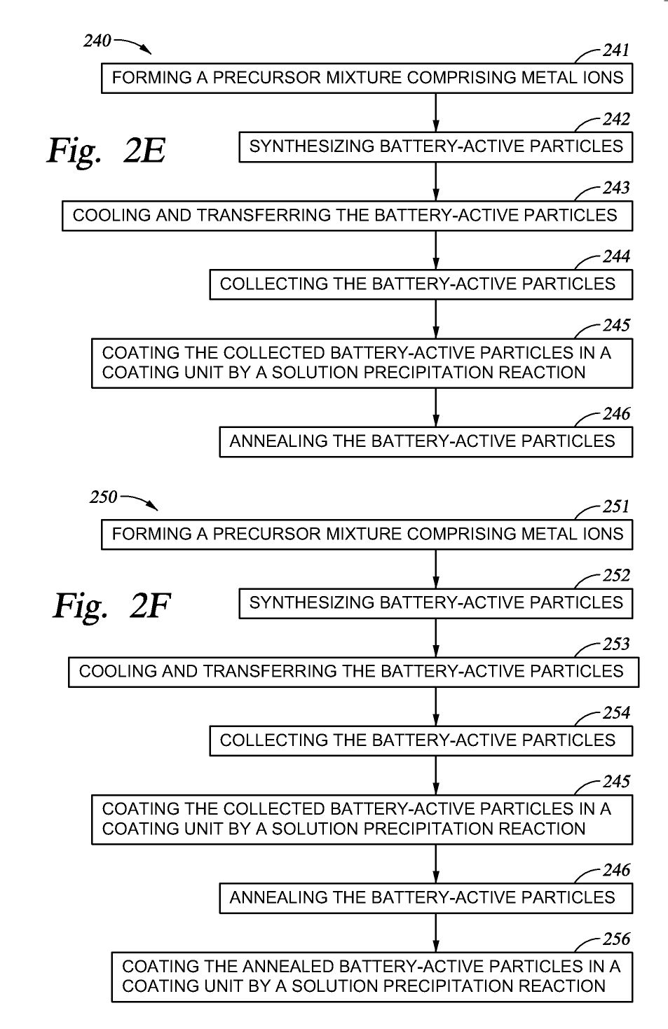

FIG. 2A is a flow chart of a method 200 for forming cathode active materials with coating according to one embodiment of the present disclosure. In method 200, a coating material is mixed directly with precursors and a thin coating is formed on particles of a solid material, such as a cathode active material, during synthesizing process when the coating precursor is segregated on the surface of the particles. The method 200 may be performed using the system 100 having the coating source unit 170A attached to the mixing unit 110.

In box 201, coating chemicals or coating precursors may be introduced to a precursor solution or precursor mixture in a mixing unit, such as the mixing unit 110 of the system 100. The precursor solution or precursor mixture comprises the coating precursor and metal ions configured to form particles of cathode active material having a thin coating by a continuous flow process. The coating precursor may comprise one or more chemicals suitable to form a thin film comprising one or more of Al₂O₃, AlF₃, LiAlO₂, AIPO₄, ZrO₂, ZrF₄, SiO₂, SnO₂, MgO. In one embodiment, the coating precursor comprises Al(NO₃)₃ or aluminum alkyl for forming a coating material comprising Al₂O₃ on the cathode active material to be formed. The ratio of the coating precursor in the precursor solution or precursor mixture is set so that less than 3% in weight of the produced cathode active material is the coating.

In box 202, the precursor solution or precursor mixture formed in box 201 is flown to a synthesizing section and is synthesized to particles with a coating. When the method 200 is performed in the system 100, the synthesizing process may be performed using the droplet generator 112, the dryer 114 and the reactor 116. During the synthesizing process, the coating precursor is segregated and formed on surfaces of the particles of the solid material being formed.

In box 203, the particles with coating formed thereon are cooled in a cooling unit, such as the cooling unit 130 and transferred through a transfer means, such as the transferring channel 134.

In box 204, the cooled particles with coating formed thereon are delivered to a collecting unit, such as the collecting unit 140 of the system 100, to be captured. The capturing process may be performed by any suitable collector. In one embodiment, the capturing process is a cyclone particle capturing process.

In box 205, the captured particles with coating flow downstream to an annealing unit to be annealed.

FIG. 2B is a flow chart of a method 210 for forming cathode active materials with coating according to one embodiment of the present disclosure. In method 210, a coating is formed post synthesizing during particle transferring. A coating precursor in the liquid or gas phase is introduced, for example, by spraying, to the synthesized particles when the particles reached target temperature, thus form a coating on the particles. The method 210 may be performed using the system 100 having the coating source unit 170B attached to the cooling unit 130.

In box 211, a precursor solution or precursor mixture in a mixing unit, such as the mixing unit 110 of the system 100. The precursor solution or mixture may include metal ions for forming cathode active material.

In box 212, the precursor solution or precursor mixture formed in box 201 is flown to a synthesizing section and is synthesized to particles with a coating. When the method 200 is performed in the system 100, the synthesizing process may be performed using the droplet generator 112, the dryer 114 and the reactor 116.

In box 213, the particles are flown to a cooling unit, such as the cooling unit 130, to be cooled and transferred through a transfer means, such as the transferring channel 134.

In box 214, coating chemicals or coating precursors may be introduced to cooled particles to form a coating thereon while flowing in a transferring channel, such as the transferring channel 134.

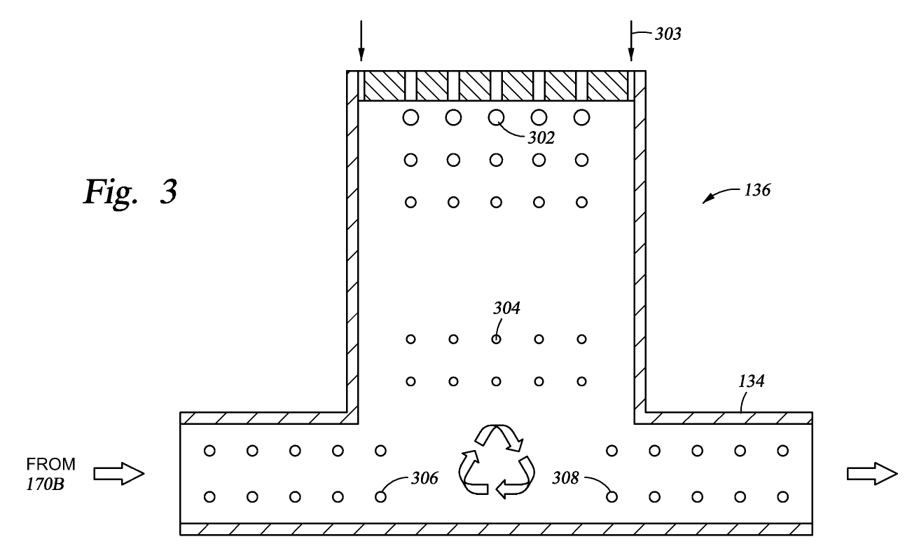

FIG. 3 schematically illustrates a reaction for coating cathode active material according to box 214 of the method 210. As shown in FIG. 3, the flow of particles 302 exits from the reactor 116 to the cooling unit 130. In one embodiment, cool air 303 may be used in the cooling unit 130 to cool the flow of particles 302. As the flow of cooled particles 304 continues to the transferring channel 134, a flow of coating chemical or precursor 306 is introduced to the transferring channel 134 from the coating source unit 170B. The coating chemical or precursor 306 and the cooled particles 304 react and form a flow of coated particles 308.

The coating chemical or precursor may comprise one or more chemicals suitable to form a thin film comprising one or more of Al₂O₃, AIF₃, LiAlO₂, AIPO₄, ZrO₂, ZrF₄, SiO₂, SnO₂, MgO. In one embodiment, the coating precursor comprises Al(NO₃)₃ or aluminum alkyl for forming a coating material comprising Al₂O₃ on the cathode active material to be formed.

In box 215 of method 210, the cooled particles with coating formed thereon are delivered to a collecting unit, such as the collecting unit 140 of the system 100, to be captured. The capturing process may be performed by any suitable collector. In one embodiment, the capturing process is a cyclone particle capturing process.

In box 216, the captured particles with coating flow downstream to an annealing unit to be annealed.

FIG. 2C is a flow chart of a method 220 for forming cathode active materials with coating according to one embodiment of the present disclosure. In method 220, a coating is formed post synthesizing during particle collecting. In one embodiment, a film of coating material on an inner surface of the particle collector so that a coating formed on the particles when the particles physically contact and scratch the inner walls of the particle collector during collecting process. The method 220 may be performed using the system 100 having the coating source unit 170C attached to the collecting unit 140.

In box 221, a precursor solution or precursor mixture in a mixing unit, such as the mixing unit 110 of the system 100. The precursor solution or mixture may include metal ions for forming cathode active material.

In box 222, the precursor solution or precursor mixture formed in box 201 is flown to a synthesizing section and is synthesized to particles with a coating. When the method 200 is performed in the system 100, the synthesizing process may be performed using the droplet generator 112, the dryer 114 and the reactor 116.

In box 223, the particles are flown to a cooling unit, such as the cooling unit 13, to be cooled and transferred through a transfer means, such as the transferring channel 134.

In box 224, the cooled particles with coating formed thereon are delivered to a collecting unit, such as the collecting unit 140 of the system 100, to be captured. The capturing process may be performed by any suitable collector. In one embodiment, the capturing process is a cyclone particle capturing process and the coating may be applied by applying a film of coating material on an inner surface of the particle collector so that a coating formed on the particles when the particles physically contact and scratch the inner walls of the particle collector during collecting process. The film of coating material may be applied to the inner surface of the particle collector by supplying a coating material from the coating source unit 170C coupled to the collecting unit 140.

In box 225, the captured particles with coating flow downstream to an annealing unit to be annealed.

FIG. 2D is a flow chart of a method 230 for forming cathode active materials with coating according to one embodiment of the present disclosure. In method 230, a coating is formed post synthesizing during annealing. A coating precursor in the liquid or gas phase is introduced, for example, by spraying, to the synthesized particles when the particles reached target temperature, thus form a coating on the particles. The method 230 may be performed using the system 100 having the coating source unit 170D attached to the annealing unit 150.

In box 231, a precursor solution or precursor mixture in a mixing unit, such as the mixing unit 110 of the system 100. The precursor solution or mixture may include metal ions for forming cathode active material.

In box 232, the precursor solution or precursor mixture formed in box 201 is flown to a synthesizing section and is synthesized to particles with a coating. When the method 200 is performed in the system 100, the synthesizing process may be performed using the droplet generator 112, the dryer 114 and the reactor 116.

In box 233, the particles flow to a cooling unit, such as the cooling unit 13, to be cooled and transferred through a transfer means, such as the transferring channel 134.

In box 234, the cooled particles are delivered to a collecting unit, such as the collecting unit 140 of the system 100, to be captured. The capturing process may be performed by any suitable collector. In one embodiment, the capturing process is a cyclone particle capturing process.

In box 235, the captured particles flow downstream to an annealing unit having a coating source unit to be annealed and coated simultaneously. In one embodiment, a coating precursor in the liquid or gas phase is introduced, for example, by spraying, to the particles in the annealing unit when the particles reached target temperature, thus form a coating on the particles.

FIG. 2E is a flow chart of a method 240 for forming cathode active materials with coating according to one embodiment of the present disclosure. In method 240, a coating is formed in an independent coating station disposed after a collecting unit and before an annealing unit. The independent coating station may perform coating on particles by a solution precipitation reaction. For example, particles of the solid material to be coated may be suspended in a solution of coating material to carry out reactions for coating. The method 240 may be performed using the system 100 having the independent coating station 160A coupled before the annealing unit 150.

In box 241, a precursor solution or precursor mixture in a mixing unit, such as the mixing unit 110 of the system 100. The precursor solution or mixture may include metal ions for forming cathode active material.

In box 242, the precursor solution or precursor mixture formed in box 201 is flown to a synthesizing section and is synthesized to particles with a coating. When the method 200 is performed in the system 100, the synthesizing process may be performed using the droplet generator 112, the dryer 114 and the reactor 116.

In box 243, the particles are flown to a cooling unit, such as the cooling unit 13, to be cooled and transferred through a transfer means, such as the transferring channel 134.

In box 244, the cooled particles are delivered to a collecting unit, such as the collecting unit 140 of the system 100, to be captured. The capturing process may be performed by any suitable collector. In one embodiment, the capturing process is a cyclone particle capturing process.

In box 245, the collected particle flow to an independent coating station, such as the independent coating station 160A, where a coating process is performed. In one embodiment, the coating process may be performed by a solution precipitation reaction. Particles of the solid material to be coated may be suspended in a solution of coating material to carry out a precipitation process resulting in coated particles. The coating source unit 170E may deliver solutions of chemicals for forming a coating, such as Al₂O₃, AIF₃, LiAlO₂, AIPO₄, ZrO₂, ZrF₄, SiO₂, SnO₂, MgO, on surfaces of the cathode active material. In one embodiment, the coating source unit 170E may deliver a solution of Al(NO₃)₃ or aluminum alkyl to the coating container 162 for forming a coating material comprising Al₂O₃ on the cathode active material.

In box 246, the coated particles flow downstream to an annealing unit to be annealed.

FIG. 2F is a flow chart of a method 250 for forming cathode active materials with coating according to one embodiment of the present disclosure. In method 250, a coating is formed on particles of solid material in standalone coating station after the solid material is formed in a particle generating system, such as the system 100. The standalone coating station may perform coating on particles by a solution precipitation reaction. For example, particles of the solid material to be coated may be suspended in a solution of coating material to carry out reactions for coating. The method 250 may be performed using the standalone coating station 160B as described in FIG. 1.

In box 251, a precursor solution or precursor mixture in a mixing unit, such as the mixing unit 110 of the system 100. The precursor solution or mixture may include metal ions for forming cathode active material.

In box 252, the precursor solution or precursor mixture formed in box 201 is flown to a synthesizing section and is synthesized to particles with a coating. When the method 200 is performed in the system 100, the synthesizing process may be performed using the droplet generator 112, the dryer 114 and the reactor 116.

In box 253, the particles flow to a cooling unit, such as the cooling unit 13, to be cooled and transferred through a transfer means, such as the transferring channel 134.

In box 254, the cooled particles are delivered to a collecting unit, such as the collecting unit 140 of the system 100, to be captured. The capturing process may be performed by any suitable collector. In one embodiment, the capturing process is a cyclone particle capturing process.

In box 255, the collected particles are flown downstream to an annealing unit to be annealed.

In box 256, the annealed particles flow to a standalone coating station, such as the independent coating station 160B, where a coating process is performed. In one embodiment, the coating process may be performed by a solution precipitation reaction. Particles of the solid material to be coated may be suspended in a solution of coating material to carry out a precipitation process resulting in coated particles. The coating source unit 170F may deliver solutions of chemicals for forming a coating, such as Al₂O₃, AIF₃, LiAlO₂, AIPO₄, ZrO₂, ZrF₄, SiO₂, SnO₂, MgO, on surfaces of the cathode active material. In one embodiment, the coating source unit 170F may deliver a solution of Al(NO₃)₃ or aluminum alkyl to the coating container 164 for forming a coating material comprising Al₂O₃ on the cathode active material.

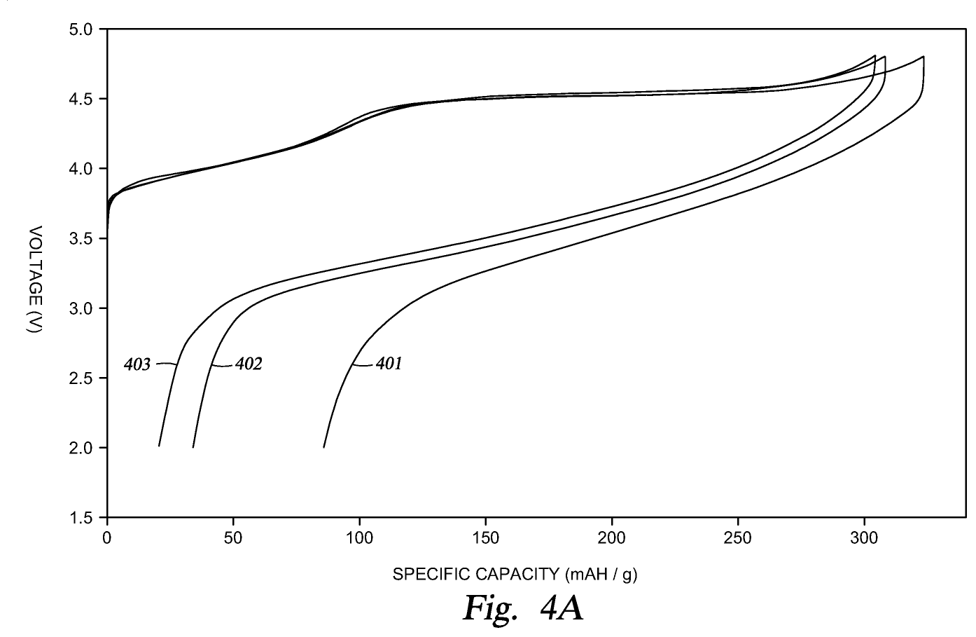

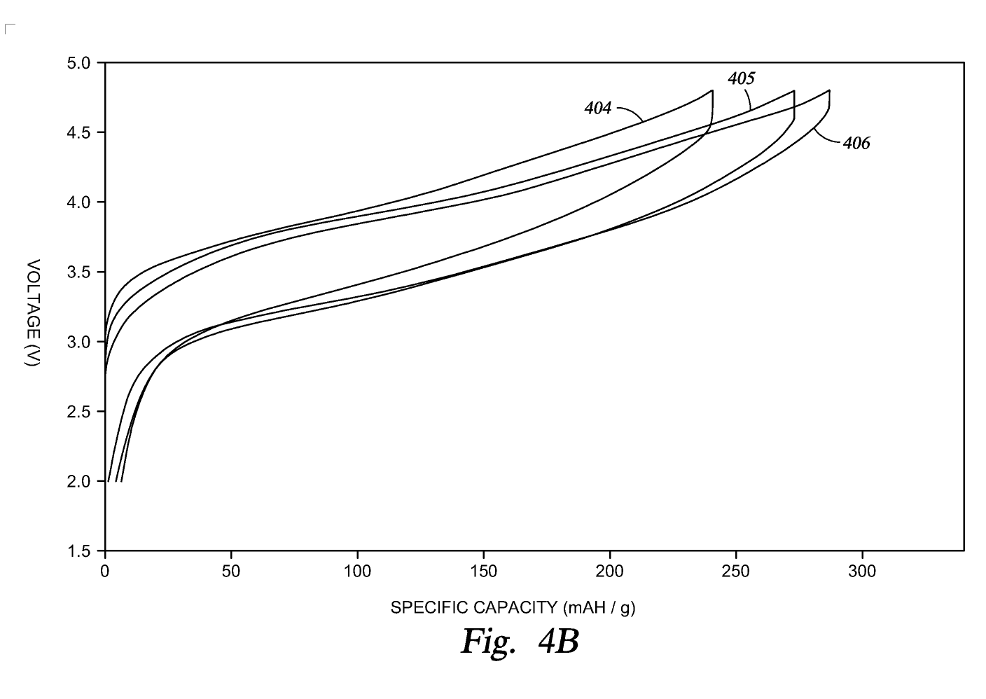

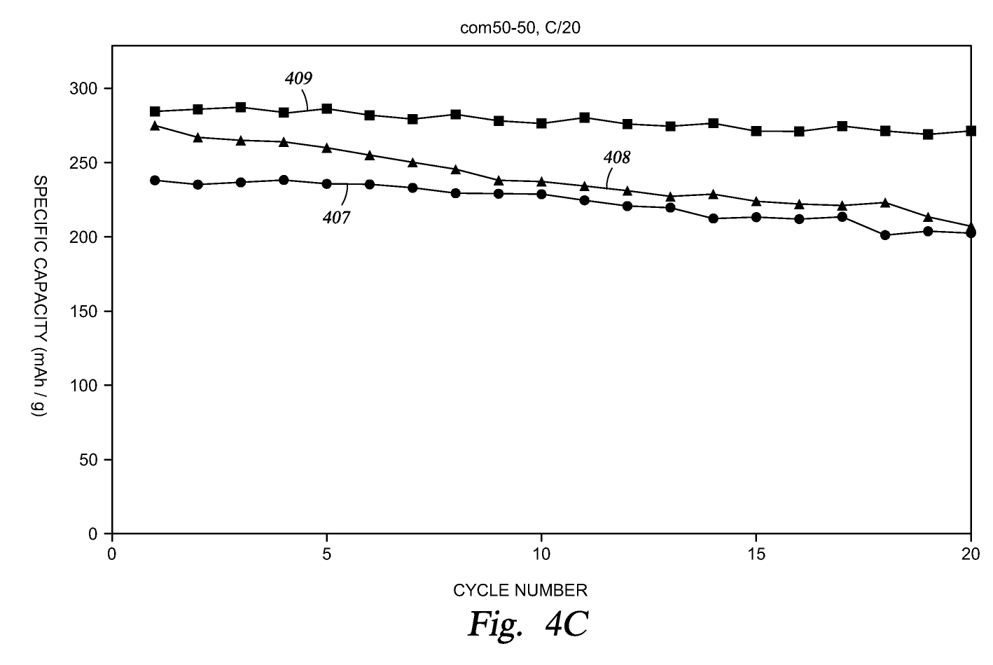

Cathode active materials formed according to embodiments of the present disclosure have shown advantages over cathode materials formed by traditional methods. Particularly, cathode active materials according to the present embodiment have shown improved cycle performance as shown in FIGS. 4A-4C.

FIG. 4A is a graph showing first cycle charge/discharge curves of batteries with various cathode active materials. Curve 401 is the first cycle charge/discharge of a conventional method synthesized cathode active material. Curve 402 is the first cycle charge/discharge of a cathode active material formed by a continuous flow method as described in FIG. 1 without any coating. Curve 403 is the first cycle charge/discharge of a cathode active material formed by a continuous flow method with sprayed coating according to embodiment of the present disclosure. The conventional method synthesized product corresponding to curve 401 shows the largest irreversible capacity. The sprayed sample corresponding to curve 403 shows the lowest irreversible capacity.

FIG. 4B is a graph showing second cycle charge/discharge curves of batteries with various cathode active materials. Curve 404 is the second cycle charge/discharge of the conventional method synthesized cathode active material. Curve 405 is the second cycle charge/discharge of the cathode active material formed by a continuous flow method without any coating. Curve 406 is the second cycle charge/discharge of the cathode active material formed by a continuous flow method with sprayed coating according to embodiment of the present disclosure. The sprayed sample corresponding to curve 406 shows the highest charge and discharge capacity.

FIG. 4C is a graph showing cycle performance of batteries with various cathode active materials. Curve 407 is specific capacity of the conventional method synthesized cathode active material. Curve 408 is specific capacity of the cathode active material formed by a continuous flow method without any coating. Curve 409 is specific capacity of the cathode active material formed by a continuous flow method with sprayed coating according to embodiment of the present disclosure. The sprayed sample corresponding to curve 409 shows the highest specific capacity and capacity retention.

While the foregoing is directed to embodiments of the disclosure, other and further embodiments of the disclosure may be devised without departing from the basic scope thereof.

What is claimed is:

1. An apparatus for forming cathode active material by continuous flow, comprising:
a mixing unit that generates a mixture or a solution of precursors;
a synthesizing unit coupled to the mixing unit to generate particles of cathode active material from the mixture or solution of precursors;
a cooling unit coupled to an outlet of the synthesizing unit;
a transferring channel coupled downstream to the cooling unit;
a collecting unit connected to the transferring channel for collecting the particles of cathode active material;
an annealing unit downstream to the collecting unit to anneal the particles of cathode active material; and
a coating source unit that provides a coating precursor for forming a coating on the particles of cathode active material, wherein the coating source unit is disposed at one of the mixing unit, the synthesizing unit, the transferring channel, the collecting unit, the annealing unit, an independent coating unit coupled between the collecting unit and the annealing unit, or a standalone coating unit.

2. The apparatus of claim 1, wherein the coating source unit is coupled to a mixer of the mixing unit, the mixing unit that generates a mixture or a solution comprising the coating precursor, and the synthesizing unit that forms particles of cathode active material having a coating formed thereon.

3. The apparatus of claim 1, wherein the coating source unit is coupled to the transferring channel, and the coating source unit that sprays a coating liquid or a coating gas to the flow of particles of cathode active material in the transferring channel.

4. The apparatus of claim 1, wherein the coating source unit is coupled to the collecting unit to form a layer of coating material on an inner surface of the collecting unit, and the particles of cathode active material is coated by the coating material while contacting the inner surface of the collecting unit.

5. The apparatus of claim 1, wherein the coating source unit is coupled to the annealing unit, and the coating source unit that sprays a coating liquid or a coating gas to the particles of cathode active material in the annealing unit during annealing.

6. The apparatus of claim 1, wherein the coating source unit is coupled to the independent coating station that carries out coating reactions to form a coating over the particles of cathode active material.

7. The apparatus of claim 1, wherein the coating source unit is coupled to the standalone coating station to carry out coating reactions to form a coating over the particles of cathode active material.

8. The apparatus of claim 1, wherein the synthesizing unit comprising a droplet generator, a dryer and a reactor.

9. The apparatus of claim 8, wherein the droplet generator is disposed in an inner volume of the dryer.

10. The apparatus of claim 9, wherein the dryer and the reactor form a tower with the dryer above the reactor.

11. A method for forming cathode active material, comprising:
forming a mixture or solution of precursors comprising metal ions;
synthesizing the mixture or solution of precursors to form particles of cathode active material;
cooling and transferring the particles of cathode active material to a collecting unit;
collecting the particles of cathode active material in the collecting unit;
annealing the collected particles of cathode active material; and
adding a coating precursor to form a coating over the particles of cathode active material, wherein adding the coating precursor is performed during one of the following: forming the mixture or solution of precursors, cooling and transferring the particles of cathode active material, collecting the particles of cathode active material, after collecting and before annealing the particles of cathode active material, annealing the particles of cathode active material, and after annealing the particles of cathode active material.

12. The method of claim 11, wherein adding the coating precursor comprises introducing a suitable amount of the coating precursor so that the coated cathode active material comprises less than about 3% in weight of coating.

13. The method of claim 11, wherein the coating comprises one of Al₂O₃, AIF₃, LiAlO₂, AIPO₄, ZrO₂, ZrF₄, SiO₂, SnO₂, MgO, or combinations thereof.

14. The method of claim 13, wherein the coating comprises Al₂O₃, and the coating precursor comprises Al(NO₃)₃ or aluminum alkyl.

15. The method of claim 11, wherein adding the coating precursor comprises introducing the coating precursor to the mixture or solution of precursors during forming the mixture or solution of precursors, and synthesizing the mixture or solution of precursors forms at least partially coated particles of cathode active material precursor.

16. The method of claim 11, wherein adding the coating precursor comprises spraying a coating liquid or a coating gas to the particles of cathode active material while transferring the powder of cathode active material.

17. The method of claim 11, wherein adding the coating precursor comprises spraying a coating liquid or a coating gas to the particles of cathode active material while annealing the powder of cathode active material.

18. The method of claim 11, wherein adding the coating precursor comprises adding the coating precursor to an independent coating station to carry out precipitation reactions to form a coating on the particles of cathode active material.

19. The method of claim 18, wherein adding the coating precursor is performed after collecting and before annealing.

20. The method of claim 18, wherein adding the coating precursor is performed after annealing.
